(19) United States
(12) Patent Application Publication
(10) Pub. No.: US 2026/0362267 A1
(43) Pub. Date: Nov. 12, 2026

(54) SERVICE SWITCHING METHOD, AND NETWORK ELEMENT AND COMPUTER-READABLE STORAGE MEDIUM

(71) Applicants: China Mobile Communication Co., Ltd Research Institute, Beijing (CN); China Mobile Communications Group Co., Ltd., Beijing (CN)

(72) Inventors: Qi SUN, Beijing (CN); Xu XUE, Beijing (CN); Ting LI, Beijing (CN); Nan LI, Beijing (CN)

(21) Appl. No.: 19/125,930

(22) PCT Filed: Oct. 30, 2023
(86) PCT No.: PCT/CN2023/127644

§ 371 Date: Apr. 30, 2025

(30) Foreign Application Priority Data
Nov. 1, 2022 (CN) 202211357010.1

(51) Int. Cl. H04W 36/08; H04W 36/00

(52) U.S. Cl. CPC H04W 36/08; H04W 36/0061

(57) ABSTRACT

Provided in the embodiments of the present disclosure are a service switching method, and a network element and a computer-readable storage medium. The method comprises: when a first network element receives a switching instruction from a terminal and confirms that a second network element has subscribed to wireless information of the terminal, querying a third network element; and the first network element sending first information to the second network element, wherein the first information is used for instructing the second network element to subscribe to, from the third network element, the wireless information of the terminal.

### CROSS-REFERENCE TO RELATED APPLICATION

This application claims the priority of Chinese Patent Application No. 202211357010.1 filed in China on Nov. 1, 2022, the disclosure of which is hereby incorporated by reference in its entirety.

### TECHNICAL FIELD

The present disclosure relates to the field of communications technologies, and in particular, to a service switching method, a network element, and a computer-readable storage medium.

### BACKGROUND

The capability exposure of the radio access network may provide near real-time wireless network state information for an edge computing platform or other external service systems, or obtain service information capable of assisting wireless network optimization from the edge computing platform or other service systems, so that an accurate Service Level Agreement (SLA) guarantee capability is enabled, and therefore, radio access network capability exposure has become a current important requirement.

On the wireless side, an Open Radio Access Network (O-RAN) defines an RAIE interface, and a near-realtime (Near-RT) layer of a radio access network intelligent controller opens more real-time wireless information and capabilities to the outside through a Near-RT RIC (RAN Intelligent Controller), so as to meet the requirements of services. Since the number and coverage of the base stations subordinate to the Near-RT RIC are limited, the Near-RT RIC, i.e., the service provider, may also be changed in the mobile scenario of the user equipment (UE).

In the mobile scenario, when a UE hands over from a base station subordinate to a Near-RIC to a base station subordinate to another Near-RIC, the service provider for wireless information exposure of the UE changes, and changes from the source Near-RT RIC to the target Near-RT RIC. Since the service consumer such as the Application Function (AF)/Local Network Exposure Function (Local NEF) does not know that the UE leaves the source Near-RT RIC, and does not know that the UE hands over to the base station of the target Near-RT RIC, incurring that the radio capability exposure service related to the UE is interrupted.

### SUMMARY

An objective of the embodiments of the present disclosure is to provide a service switching method, a network element, and a computer-readable storage medium, to resolve a problem that a wireless capability exposure service is easily interrupted in a mobile scenario of a UE in the related art.

To address the above technical problem, a service switching method is provided. The method includes:
when a first network element receives a handover indication of a terminal and confirms that a second network element has subscribed to wireless information of the terminal, querying a third network element by the first network element; and
sending first information to the second network element by the first network element, wherein the first information is used to indicate the second network element to subscribe to the wireless information of the terminal from the third network element.

Wherein the querying a third network element by the first network element includes:
parsing the handover indication of the terminal by the first network element, and determining the identification information of a target base station to which the terminal hands over;
querying, by the first network element, the third network element corresponding to the target base station based on the identification information of the target base station.

Wherein querying, by the first network element, the third network element corresponding to the target base station according to the identification information of the target base station includes:
when the first network element locally stores information of a neighbor network element, searching the locally stored information of the neighbor network element by the first network element, and querying the third network element corresponding to the target base station.

Wherein querying, by the first network element, the third network element corresponding to the target base station according to the identification information of the target base station includes:
sending second information to a fourth network element by the first network element, wherein the second information is used to request the fourth network element to query the third network element corresponding to the target base station;
receiving third information from the fourth network element by the first network element, wherein the third information is used to indicate a query result of the third network element.

Wherein the third information carries at least one of the following information:
an identifier indicating whether the querying is successful;
identification information of the third network element;
an IP address of the third network element.

Wherein when querying the third network element fails, the method further includes:
sending fourth information to the second network element by the first network element, wherein the fourth information is used to notify the second network element that a wireless capability exposure service of the terminal is interrupted.

Wherein when querying the third network element succeeds, then before the first network element sends the first information to the second network element, the method further includes:
sending fifth information to the third network element by the first network element, wherein the fifth information is used to indicate that a terminal-level capability exposure service subscribed by the second network element needs to be switched to the third network element;
receiving sixth information from the third network element by the first network element, wherein the sixth information is used to indicate a response result of the third network element.

Wherein when querying the third network element succeeds, then before the first network element sends the first information to the second network element, the method further includes:
sending seventh information to a fourth network element by the first network element, wherein the seventh information carries service switching requirement information;
receiving eighth information from the fourth network element by the first network element, wherein the eighth information is used to indicate the first network element to trigger service switching of the second network element.

Wherein the fifth information and/or the seventh information carry at least one of the following information:
a message type;
a service identifier allocated when the first network element provides an exposure service for the second network element;
a cause for service switching;
an identifier of a target base station;
information of the second network element;
subscription information of the second network element.

Wherein the subscription information of the second network element includes at least one of the following:
an IP address of the terminal;
identification information of the terminal;
subscribed terminal-level information.

Wherein the sixth information and/or the eighth information carry at least one of the following:
a message type;
a service identifier allocated when the first network element provides an exposure service for the second network element;
a service identifier allocated when the third network element provides an exposure service for the second network element;
a response result indicating that the sixth information is a success response or a failure response;
uniform resource locator (URL) of a subscription capability exposure service provided by the third network element for the second network element.

Wherein sending the first information to the second network element by the first network element includes:

when the response result of the third network element is a success response or that the eighth information is received, sending the first information to the second network element by the first network element.

Wherein, the method further includes:
when the response result of the third network element is a failure response, sending ninth information to the second network element by the first network element, wherein the ninth information is used to indicate that the terminal moves to the third network element, and the third network element does not support a service to which the second network element has subscribed.

Wherein the first information and/or the ninth information carry at least one of the following information:
information of the third network element;
identification information of a target base station to which the terminal hands over;
identification information of a target cell to which the terminal hands over;
identification information of the terminal performing handover;
an IP address of the terminal performing handover.

Wherein the information of the third network element includes at least one of the following:
identification information of the third network element;
URL of the subscription capability exposure service provided by the third network element to the second network element;
that the third network element does not support a service to which the second network element has subscribed.

A service switching method is provided. The method includes:
receiving first information from a first network element by a second network element, wherein the second network element has subscribed to wireless information of a terminal from the first network element;
subscribing to the wireless information of the terminal by the second network element from a third network element indicated by the first information according to the first information.

Wherein, the method further includes:
receiving ninth information from the first network element by the second network element, wherein the ninth information is used to indicate that the terminal moves to the third network element, and the third network element does not support a service to which the second network element has subscribed.

Wherein the first information and/or the ninth information carry at least one of the following information:
information of the third network element;
identification information of a target base station to which the terminal hands over;
identification information of a target cell to which the terminal hands over;
identification information of the terminal performing handover;
an IP address of the terminal performing handover.

Wherein the information of the third network element includes at least one of the following:
identification information of the third network element;
URL of the subscription capability exposure service provided by the third network element to the second network element;
that the third network element does not support a service to which the second network element has subscribed.

Wherein before subscribing to the wireless information of the terminal by the second network element from a third network element indicated by the first information according to the first information, the method further includes:
initiating an authentication process to the third network element by the second network element;
subscribing to the wireless information of the terminal by the second network element from the third network element indicated by the first information according to the first information includes:
when authentication succeeds, subscribing to the wireless information of the terminal from the third network element by the second network element, and sending a subscription deletion message to the first network element, wherein the subscription deletion message is used to indicate the first network element to delete the wireless information of the terminal subscribed by the second network element.

A service switching method is provided. The method includes:
receiving fifth information from a first network element or a fourth network element by a third network element, wherein the fifth information is used to indicate that a terminal-level capability exposure service subscribed by a second network element needs to be switched to the third network element;
sending sixth information to the first network element or the fourth network element by the third network element, wherein the sixth information is used to indicate a response result of the third network element.

Wherein the fifth information carries at least one of the following information:
a message type;
a service identifier allocated when the first network element provides an exposure service for the second network element;
a cause for service switching;
an identifier of a target base station;
information of the second network element;
subscription information of the second network element.

Wherein the subscription information of the second network element includes at least one of the following:
an IP address of the terminal;
identification information of the terminal;
subscribed terminal-level information.

Wherein the sixth information carries at least one of the following:
a message type;
a service identifier allocated when the first network element provides an exposure service for the second network element;
a service identifier allocated when the third network element provides an exposure service for the second network element;
a response result indicating that the sixth information is a success response or a failure response;
uniform resource locator (URL) of a subscription capability exposure service provided by the third network element for the second network element.

Wherein before sending the sixth information to the first network element or the fourth network element by the third network element, the method further includes:
checking, by the third network element, whether a target base station is managed by the third network element, whether the third network element supports a service subscribed by the second network element, and whether capability of the third network element itself can support service subscription of the second network element;
when the checking is all passed, determining that the response result of the third network element is the success response; or, when at least one of the checking fails, determining that the response result of the third network element is the failure response.

Wherein, the method further includes:
responding by the third network element to an authentication process initiated by the second network element;
when the authentication is successfully passed, receiving by the third network element a subscription request of wireless information of the terminal from the second network element;
providing a wireless capability exposure service of the terminal for the second network element by the third network element in response to a subscription request of the second network element.

A service switching method is provided. The method includes:
receiving seventh information from a first network element by a fourth network element, wherein the seventh information carries service switching requirement information;
sending eighth information to the first network element by the fourth network element, wherein the eighth information is used to indicate the first network element to trigger service switching of the second network element.

Wherein the seventh information carries at least one of the following information:
a message type;
a service identifier allocated when the first network element provides an exposure service for the second network element;
a cause for service switching;
an identifier of a target base station;
information of the second network element;
subscription information of the second network element.

Wherein the subscription information of the second network element includes at least one of the following:
an IP address of the terminal;
identification information of the terminal;
subscribed terminal-level information.

Wherein the eighth information carries at least one of the following:
a message type;
a service identifier allocated when the first network element provides an exposure service for the second network element;
a service identifier allocated when the third network element provides an exposure service for the second network element;
a response result indicating that the sixth information is a success response or a failure response;
uniform resource locator (URL) of a subscription capability exposure service provided by the third network element for the second network element.

Wherein, the method further includes:
receiving second information from the first network element by the fourth network element, wherein the second information is used to request the fourth network element to query a third network element corresponding to the target base station;
sending third information to the first network element by the fourth network element, wherein the third information is used to indicate a query result of the third network element.

Wherein the third information carries at least one of the following information:
an identifier indicating whether the querying is successful;
identification information of the third network element;
an IP address of the third network element.

A first network element including a processor and a transceiver is provided, wherein the transceiver receives and sends data under the control of the processor, wherein the processor is configured to perform the following operations:
when receiving a handover indication of a terminal and determining that a second network element has subscribed to wireless information of the terminal, querying a third network element;
sending first information to the second network element, wherein the first information is used to indicate the second network element to subscribe to the wireless information of the terminal from the third network element.

A second network element including a processor and a transceiver is provided, wherein the transceiver receives and sends data under the control of the processor, wherein the processor is configured to perform the following operations:
receiving first information from a first network element, wherein the second network element has subscribed to wireless information of a terminal from the first network element;
subscribing to the wireless information of the terminal from a third network element indicated by the first information according to the first information.

A third network element including a processor and a transceiver is provided, wherein the transceiver receives and sends data under the control of the processor, wherein the processor is configured to perform the following operations:
receiving fifth information from a first network element or a fourth network element, wherein the fifth information is used to indicate that a terminal-level capability exposure service subscribed by a second network element needs to be switched to the third network element;
sending sixth information to the first network element or the fourth network element, wherein the sixth information is used to indicate a response result of the third network element.

A fourth network element including a processor and a transceiver is provided, wherein the transceiver receives and sends data under the control of the processor, wherein the processor is configured to perform the following operations:
receiving seventh information from a first network element, wherein the seventh information carries service switching requirement information;
sending eighth information to the first network element, wherein the eighth information is used to indicate the first network element to trigger service switching of the second network element.

A network element including a memory, a processor, and a program stored on the memory and executable on the processor is provided; wherein when the processor executes the program, the service switching methods provided above are implemented.

A computer-readable storage medium having a computer program stored thereon is provided, wherein when the computer program is executed by a processor, steps in the service switching methods provided above are implemented.

The above technical solution of the present disclosure has at least the following beneficial effects:
in the service switching method, the network element, and the computer-readable storage medium of the embodiments of the present disclosure, in a mobile scenario of the terminal, after the first network element senses that the terminal moves to the third network element, the second network element is notified to indicate the second network element to initiate the subscription of the wireless information exposure service to the third network element, and then the third network element continues to provide the wireless capability exposure service of the terminal for the second network element, thereby avoiding the interruption problem of the wireless capability exposure service in the mobile scenario of the terminal.

### BRIEF DESCRIPTION OF THE DRAWINGS

FIG. 1 is a first flowchart of a service switching method according to an embodiment of the present disclosure;

FIG. 2 is a first schematic diagram of an application scenario of a service switching method according to an embodiment of the present disclosure;

FIG. 3 is a second schematic diagram of an application scenario of a service switching method according to an embodiment of the present disclosure;

FIG. 4 is a third schematic diagram of an application scenario of a service switching method according to an embodiment of the present disclosure;

FIG. 5 is a second flowchart of a service switching method according to an embodiment of the present disclosure;

FIG. 6 is a third flowchart of a service switching method according to an embodiment of the present disclosure;

FIG. 7 is a fourth flowchart of a service switching method according to an embodiment of the present disclosure;

FIG. 8 is a schematic diagram of a principle of Example 1 according to an embodiment of the present disclosure;

FIG. 9 is a schematic diagram of a principle of Example 2 according to an embodiment of the present disclosure;

FIG. 10 is a schematic structural diagram of a first network element according to an embodiment of the present disclosure;

FIG. 11 is a schematic structural diagram of a second network element according to an embodiment of the present disclosure;

FIG. 12 is a schematic structural diagram of a third network element according to an embodiment of the present disclosure;

FIG. 13 is a schematic structural diagram of a fourth network element according to an embodiment of the present disclosure.

### DETAILED DESCRIPTION

In order to make the technical problems, technical solutions and advantages to be solved by the present disclosure clearer, the following describes in detail with reference to the accompanying drawings and specific embodiments.

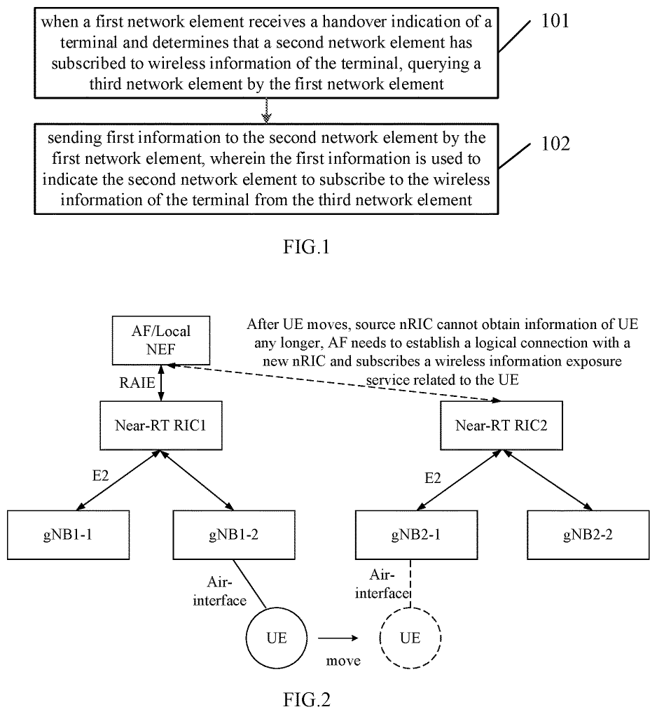

As shown in FIG. 1, an embodiment of the present disclosure provides a service switching method, including following steps.

Step 101: when a first network element receives a handover indication of a terminal and confirms that a second network element has subscribed to wireless information of the terminal, querying a third network element by the first network element.

In this step, that the second network element has subscribed to the wireless information of the terminal may be understood as that the second network element has subscribed to the wireless information of the terminal to the first network element, and in this case, the first network element provides the wireless capability exposure service of the terminal for the second network element.

Optionally, if the first network element queries the third network element, it may be understood that the first network element perceives that the terminal moves to the third network element; and if the first network element does not query the third network element, it may be understood that the first network element does not perceive which network element the terminal moves to.

Step 102: sending first information to the second network element by the first network element, wherein the first information is used to indicate the second network element to subscribe to the wireless information of the terminal from the third network element; and
In this step, when the first network element queries the third network element, the first network element notifies the second network element by using the first information, and suggests or indicates the second network element to initiate the subscription of the wireless information exposure service to the third network element; after the second network element completes the subscription of the wireless information of the terminal on the third network element, the third network element continues to provide the wireless capability exposure service of the terminal for the second network element, thereby avoiding the interruption problem of the wireless capability exposure service in the mobile scenario of the terminal.

Optionally, the first network element is a source Near-RT RIC, i.e., the Near-RT RIC of the base station (the next Generation Node B, gNB) to which the terminal (UE) belongs before moving, for example, as shown in FIG. 2, the first network element is a Near-RT RIC 1, which may be referred to as nRIC1 for short.

Optionally, the third network element is a target Near-RT RIC, that is, a Near-RT RIC of the gNB to which the UE belongs after the moving, for example, as shown in FIG. 2, the third network element is a Near-RT RIC 2, which may be referred to as nRIC2 for short.

Optionally, the second network element is a service consumer of the wireless information exposure, such as an AF or a Local NEF; for example, as shown in FIG. 2, the second network element is an AF/Local NEF.

In at least one embodiment of the present disclosure, the fourth network element stores network topology structure information of the nRIC, as shown in Table 1. Optionally, each nRIC stores information about a having an neighboring relationship with the nRIC, as shown in Table 2.

TABLE 1
Network topology structure information of the
nRIC stored in the fourth network element

| IE name | Type | Description |
|---|---|---|
| nRIC ID | INT | an identifier of nRIC |
| nRIC IP | STRING | an IP address of nRIC |
| List of Neighbor nRIC | | an nRIC neighboring the |
| | | nRIC |
| >nRIC ID | | an identifier of nRIC |
| >nRIC IP | | an IP address of nRIC |
| List of gNB | | a list of gNBs managed by |
| | | the nRIC |
| >Global RAN Node ID | INT | an identifier of gNB |
| >gNB Status | BOOL | Status of E2 connection of |
| | | gNB |

TABLE 2
neighbor nRIC information stored in each nRIC

| IE name | Type | Description |
|---|---|---|
| List of Neighbor nRIC | | neighbor nRIC of the nRIC |
| >RIC ID | | identifier of nRIC |
| >nRIC IP | | IP address of nRIC |
| List of gNB | | a list of gNBs managed by |
| | | the nRIC |
| >Global RAN Node ID | INT | Identifier of gNB |
| >gNB Status | BOOL | Status of E2 connection of |
| | | gNB |

In at least one embodiment of the present disclosure, step 201 includes:
parsing the handover indication of the terminal by the first network element, and determining the identification information of a target base station to which the terminal hands over;
querying, by the first network element, the third network element corresponding to the target base station based on the identification information of the target base station.

For example, the source nRIC (i.e. the first network element) subscribes to the switching event notification service of the UE from the source gNB, which is triggered by a UE handover event in a UE Information Change (UE Information Change) event type; the source gNB receives a handover response message of a target gNB (if the NG handover, then a handover command message; and if the Xn handover, then the handover request acknowledgement message), the source gNB reports a corresponding handover indication of the terminal to the source nRIC, which carries the information of the target gNB and the information of the target cell. 3: After receiving the handover indication of the terminal reported by the source gNB, the source nRIC parses the identifier of the target gNB (for example, the ID of the target gNB); and queries, according to the identifier of the target gNB, the third network element corresponding to the target gNB.

In an optional embodiment, if the first network element stores information about the neighbor nRIC having a neighbor relationship with the first network element, then querying, by the first network element, the third network element corresponding to the target base station according to the identification information of the target base station includes:
when the first network element locally stores information of a neighbor network element, searching the locally stored information of the neighbor network element by the first network element, and querying the third network element corresponding to the target base station. For example, the first network element searches in Table 2 for a third network element corresponding to the target base station based on the identifier of the target base station.

In another optional embodiment, in a case that the fourth network element stores the network topology structure information of the nRIC, querying, by the first network element, the third network element corresponding to the target base station according to the identification information of the target base station includes:
sending second information to a fourth network element by the first network element, wherein the second information is used to request the fourth network element to query the third network element corresponding to the target base station;
receiving third information from the fourth network element by the first network element, wherein the third information is used to indicate a query result of the third network element.

Optionally, the fourth network element is a Service Management And Orchestration (SMO) platform or a Non-Real-Time Radio access network Intelligent Controller (Non-RT RIC).

Optionally, the first network element sends second information to the SMO or the Non-RT RIC by using an enhanced O1 or A1 interface message, to request to query third network element information corresponding to the target gNB, where the second information includes an identifier of the target gNB. The identifier of the target gNB may specifically be a Global Radio Access Network Node ID (that is, a Global RAN Node ID). The SMO or the Non-RT RIC searches for the information of the nRIC, that is, the target nRIC, to which the target gNB belongs according to the global RAN Node ID and the table 1, and sends the information of the target nRIC to the first network element through the third information.

For example, as shown in Table 3, the third information carries at least one of the following information:
an identifier (Result) indicating whether the querying is successful;
identification information of the third network element; such as the identifier of the target nRIC;
an IP address of the third network element; such as the IP address of the target nRIC.

TABLE 3
Content carried in the third information

| IE name | Type | Description |
|---|---|---|
| Result | BOOL | True: successful identification; false: failed |
| | | identification |
| nRIC ID | INT | Identifier of nRIC: if a query result is fail, |
| | | the value of the identifier is 0 or the field |
| | | is not included |
| nRIC IP | STRING | IP address of nRIC: if a query result is fail, |
| | | then the value is NULL or the field is not |
| | | included |

In at least one embodiment of the present disclosure, if the third network element is not queried, the method further includes:
sending fourth information to the second network element by the first network element, wherein the fourth information is used to notify the second network element that a wireless capability exposure service of the terminal is interrupted.

Optionally, the fourth information may further carry a reason of the current service interruption, for example, the next-hop nRIC is not found.

In other words, if the target nRIC is not found, the failure response processing procedure is performed: the AF service is notified of the interruption, because the next-hop nRIC is not found.

In at least one embodiment of the present disclosure, if a target nRIC is found, a successful response processing procedure is executed; specifically, before step 102, the method further includes:
sending fifth information to the third network element by the first network element, wherein the fifth information is used to indicate that a terminal-level capability exposure service subscribed by the second network element needs to be switched to the third network element;
receiving sixth information from the third network element by the first network element, wherein the sixth information is used to indicate a response result of the third network element.

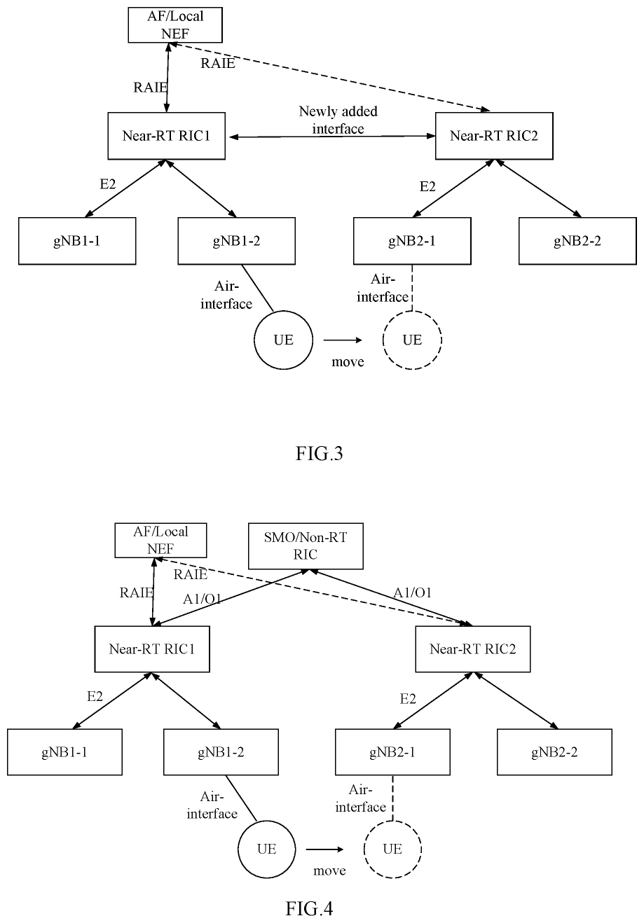

The transmission of the fifth information and the sixth information may be understood as a preparation process of service switching, as shown in FIG. 3, before indicating the second network element to perform service switching, the first network element directly interchanges the preparation information required for service switching through the newly added interface between the nICs.

In at least one embodiment of the present disclosure, if a target nRIC is found, a successful response processing procedure is executed; specifically, before step 102, the method further includes:
sending seventh information to a fourth network element by the first network element, wherein the seventh information carries service switching requirement information;
receiving eighth information from the fourth network element by the first network element, wherein the eighth information is used to indicate the first network element to trigger service switching of the second network element.

The transmission of the seventh information and the eighth information may be understood as a preparation process of service switching, as shown in FIG. 4, an interface is not newly added between the nRICs, but enhancement is made to an existing O1 or A1 interface (a Near-RT RIC and SMO or Non-RT RIC interface), and preparation information required for service switching is forwarded by the SMO/Non-RT RIC.

In an optional embodiment, the fifth information and/or the seventh information carries at least one of the following information:
a message type;
a service identifier allocated when the first network element provides an exposure service for the second network element;
a cause for service switching;
an identifier of a target base station;
information of the second network element;
subscription information of the second network element.

The subscription information of the second network element includes at least one of the following:
an IP address of the terminal;
identification information of the terminal;
subscribed terminal-level information.

For example, content carried in the fifth information and/or the seventh information is shown in Table 4.

TABLE 4
Content carried in the fifth information
and/or the seventh information

| IE name | Type | Description |
|---|---|---|
| Message type | INT | |
| ID of a source | INT | Identifier ID of a service |
| exposure service | | allocated when source nRIC |
| | | provides the exposure service to |
| | | the AF |
| Cause | Enumerated | Reason of service switching |
| Target gNB ID | INT | Identifier of a target gNB |
| AF information | STRING | Including AF ID, AF type, AF |
| | | name and the like |
| AF subscription | | |
| information | | |
| > UE IP | STRING | IP address of UE |
| > UE ID | INT | ID allocated to UE by the core |
| | | network, i.e., AMF NGAP UE |
| | | ID |
| >subscribed | STRING | For example, UE location |
| UE-level | | information, mobile speed, data |
| information | | transmission speed, delay, and |
| | | the like |

In an optional embodiment, the sixth information and/or the eighth information carries at least one of the following:
a message type;
a service identifier allocated when the first network element provides an exposure service for the second network element;
a service identifier allocated when the third network element provides an exposure service for the second network element;
a response result indicating that the sixth information is a success response or a failure response;
Uniform Resource Locator (URL) of a subscription capability exposure service provided by the third network element for the second network element.

Optionally, after receiving the fifth information or the seventh information, the target nRIC determines whether the target gNB is under control of the target nRIC, whether the service subscribed by the AF is supported, and whether capability of the target nRIC itself can support the service subscription of the AF.
a) If the check is passed, then sending a success response to the source nRIC, the message including the response type and the URL of the capability exposure service provided by the nRIC;
b) If there is at least one check not passed, a failure response is sent to the source nRIC.

For example, content carried in the sixth information and/or the eighth information is shown in Table 5.

TABLE 5
Content carried in the sixth information
and/or the eighth information

| IE name | Type | Description |
|---|---|---|
| Message Type | Enumerate | Message type |
| ID of exposure | INT | A identifier ID of a service allocated when a |
| service of a | | source nRIC provides the exposure service to |
| source nRIC | | AF |
| ID of exposure | INT | A identifier ID of a service allocated when a |
| service of a | | target nRIC provides the exposure service to |
| target nRIC | | AF |
| Result | BOOL | If the response is success, the value is true; |
| | | If the response is fail, the value is false |
| List of Service | STRING | URL of a subscription capability exposure |
| URL | | service provided to AF by a target nRIC |
| | | when the response is success, it is possible |
| | | that each service corresponds to one URL, |
| | | such as different services which may be a |
| | | moving speed of the terminal, location, |
| | | radio transmission delay, SLA configuration; |
| | | NULL if the response is fail |

After the preparation process of the service switching is completed, step 102 includes:
when the response result of the third network element is a success response or that the eighth information is received, sending the first information to the second network element by the first network element.

In another optional embodiment of the present disclosure, the method further includes:
when the response result of the third network element is a failure response, sending ninth information to the second network element by the first network element, wherein the ninth information is used to indicate that the terminal moves to the third network element, and the third network element does not support a service to which the second network element has subscribed.

In other words, in the case that the target nRIC does not support the capability exposure service subscribed by the AF, the source nRIC notifies to the AF through the ninth information that a certain UE moves to the target nRIC, and the target nRIC does not support the currently subscribed service. In a case that the target nRIC supports the capability exposure service subscribed by the AF, the source nRIC notifies to the AF through the first information that a certain UE moves to the target nRIC, and may initiate a service subscription request to the target nRIC.

Optionally, the first information and/or the ninth information carry at least one of the following information:
information of the third network element;
identification information of a target base station to which the terminal hands over;
identification information of a target cell to which the terminal hands over;
identification information of the terminal performing handover;
an IP address of the terminal performing handover.

The information of the third network element includes at least one of the following:
identification information of the third network element;
URL of the subscription capability exposure service provided by the third network element to the second network element;
that the third network element does not support a service to which the second network element has subscribed.

For example, content carried in the first information and/or the ninth information is shown in Table 6.

TABLE 6
Content carried in the first information and/or the ninth information

| IE name | Type | Description |
|---|---|---|
| Target nRIC | | |
| information | | |
| >identifier of target | STRING | Used to initiate registration, |
| nRIC | | authentication and so on to nRIC by |
| | | AF |
| >URL of capability | STRING | Used when AF subscribes capability |
| exposure service of | | exposure service to the target nRIC by |
| a target nRIC | | AF |
| | | If being“00000000”, then indicating |
| | | that the target nRIC does not support |
| | | this service |
| ID of target gNB | INT | Identifier of target gNB to which the |
| | | UE hands over |
| ID of a target cell | INT | Identifier of a target cell to which |
| | | the UE hands over |
| ID of UE subject to | INT | ID allocated to UE by core network, |
| handover | | i.e., UENGAPID |
| IP address of UE | STRING | Used to indicate to AF which UE |
| subject to handover | | hands over to the target nRIC |

In conclusion, in the moving scenario of the terminal, after the first network element senses that the terminal moves to the third network element, the first network element notifies the second network element so as to indicate the second network element to initiate the subscription of the wireless information exposure service to the third network element, and the third network element subsequently continues to provide the wireless capability exposure service of the terminal for the second network element, thereby avoiding the interruption problem of the wireless capability exposure service in the mobile scenario of the terminal.

As shown in FIG. 5, an embodiment of the present disclosure further provides a service switching method, including following steps.

Step 501: receiving first information from a first network element by a second network element, wherein the second network element has subscribed to wireless information of a terminal from the first network element; in this case, the first network element provides a wireless capability exposure service of the terminal for the second network element;
Step 502: subscribing to the wireless information of the terminal by the second network element from a third network element indicated by the first information according to the first information;
In this step, when the first network element queries the third network element, the first network element notifies the second network element by using the first information, and suggests or indicates the second network element to initiate the subscription of the wireless information exposure service to the third network element; after the second network element completes the subscription of the wireless information of the terminal on the third network element, the third network element continues to provide the wireless capability exposure service of the terminal for the second network element, thereby avoiding the interruption problem of the wireless capability exposure service in the mobile scenario of the terminal.

Optionally, the first network element is a source Near-RT RIC, i.e., the Near-RT RIC of the base station (gNB) to which the terminal (UE) belongs before moving, for example, as shown in FIG. 2, the first network element is a Near-RT RIC 1, which may be referred to as nRIC1 for short.

Optionally, the third network element is a target Near-RT RIC, that is, a Near-RT RIC of the gNB to which the UE belongs after the moving, for example, as shown in FIG. 2, the third network element is a Near-RT RIC 2, which may be referred to as nRIC2 for short.

Optionally, the second network element is a service consumer of the wireless information exposure, such as an AF or a Local NEF; for example, as shown in FIG. 2, the second network element is an AF/Local NEF.

In at least one embodiment of the present disclosure, the method further includes:
receiving ninth information from the first network element by the second network element, wherein the ninth information is used to indicate that the terminal moves to the third network element, and the third network element does not support a service to which the second network element has subscribed.

In other words, in the case that the target nRIC does not support the capability exposure service subscribed by the AF, the source nRIC notifies to the AF through the ninth information that a certain UE moves to the target nRIC and the target nRIC does not support the currently subscribed service. In a case that the target nRIC supports the capability exposure service subscribed by the AF, the source nRIC notifies to the AF through the first information that a certain UE moves to the target nRIC, and may initiate a service subscription request to the target nRIC.

Optionally, the first information and/or the ninth information carry at least one of the following information:
information of the third network element;
identification information of a target base station to which the terminal hands over;
identification information of a target cell to which the terminal hands over;
identification information of the terminal performing handover;
an IP address of the terminal performing handover.

The information about the third network element includes at least one of the following:
identification information of the third network element;
URL of the subscription capability exposure service provided by the third network element to the second network element;
that the third network element does not support a service to which the second network element has subscribed.

For example, content carried in the first information and/or the ninth information is shown in Table 6. The content of Table 6 is described in the foregoing embodiments, and details are not described herein again.

Before at least one embodiment of the present disclosure, before step 502, the method further includes: initiating an authentication process to the third network element by the second network element. Because the first network element has passed the information of the AF to the target nRIC, the AF can successfully pass the authentication process;
Correspondingly, step 502 includes:
when authentication succeeds, subscribing to the wireless information of the terminal from the third network element by the second network element, and sending a subscription deletion message to the first network element, wherein the subscription deletion message is used to indicate the first network element to delete the wireless information of the terminal subscribed by the second network element. The target nRIC may subsequently continue to provide the AF with the wireless capability exposure service of the UE, thereby implementing service switching, and avoiding the interruption problem of the wireless capability exposure service in the mobile scenario of the terminal.

In conclusion, in the moving scenario of the terminal, after the first network element senses that the terminal moves to the third network element, the first network element notifies the second network element so as to indicate the second network element to initiate the subscription of the wireless information exposure service to the third network element, and the third network element subsequently continues to provide the wireless capability exposure service of the terminal for the second network element, thereby avoiding the interruption problem of the wireless capability exposure service in the mobile scenario of the terminal.

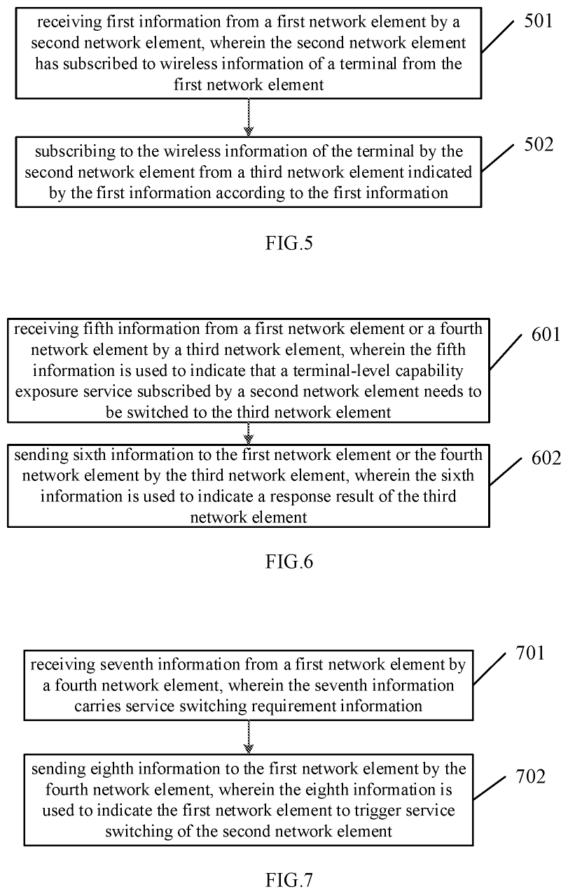

As shown in FIG. 6, an embodiment of the present disclosure further provides a service switching method, including following steps.
Step 601: receiving fifth information from a first network element or a fourth network element by a third network element, wherein the fifth information is used to indicate that a terminal-level capability exposure service subscribed by a second network element needs to be switched to the third network element;
Step 602: sending sixth information to the first network element or the fourth network element by the third network element, wherein the sixth information is used to indicate a response result of the third network element.

Optionally, the first network element is a source Near-RT RIC, i.e., the Near-RT RIC of the base station (gNB) to which the terminal (UE) belongs before moving, for example, as shown in FIG. 2, the first network element is a Near-RT RIC 1, which may be referred to as nRIC1 for short.

Optionally, the third network element is a target Near-RT RIC, that is, a Near-RT RIC of the gNB to which the UE belongs after the moving, for example, as shown in FIG. 2, the third network element is a Near-RT RIC 2, which may be referred to as nRIC2 for short.

Optionally, the second network element is a service consumer of the wireless information exposure, such as an AF or a Local NEF; for example, as shown in FIG. 2, the second network element is an AF/Local NEF.

Optionally, the fourth network element is a Service Management And Orchestration (SMO) platform or a Non-Real-Time Radio access network Intelligent Controller (Non-RT RIC).

The transmission of the fifth information and the sixth information may be understood as a preparation process of service switching, as shown in FIG. 3, before instructing the second network element to perform service switching, the first network element directly interchanges the preparation information required for service switching through the newly added interface between the nICs. Optionally, as shown in FIG. 4, an interface is not newly added between the nRICs, but enhancement is made to an existing O1 or A1 interface (a Near-RT RIC and SMO or Non-RT RIC interface), and preparation information required for service switching is forwarded by the SMO/Non-RT RIC.

Optionally, the fifth information carries at least one of the following information:
a message type;
a service identifier allocated when the first network element provides an exposure service for the second network element;
a cause for service switching;
an identifier of a target base station;
information of the second network element;
subscription information of the second network element.

The subscription information of the second network element includes at least one of the following:
an IP address of the terminal;
identification information of the terminal;
subscribed terminal-level information.

For example, the content carried in the fifth information is shown in Table 4. The content of Table 4 has been described in the above embodiments, which will not be repeated here.

Optionally, the sixth information carries at least one of the following:
a message type;
a service identifier allocated when the first network element provides an exposure service for the second network element;
a service identifier allocated when the third network element provides an exposure service for the second network element;
a response result indicating that the sixth information is a success response or a failure response;
uniform resource locator (URL) of a subscription capability exposure service provided by the third network element for the second network element.

For example, the content carried in the fifth information is shown in Table 5. The content of Table 5 is described in the foregoing embodiments, and details are not described herein again.

In at least one embodiment of the present disclosure, before step 602, the method further includes:
checking, by the third network element, whether a target base station is managed by the third network element, whether the third network element supports a service subscribed by the second network element, and whether capability of the third network element itself can support service subscription of the second network element;
when the checking is all passed, determining that the response result of the third network element is the success response; or, when at least one of the checking fails, determining that the response result of the third network element is the failure response.

In an embodiment, the method further includes:
responding by the third network element to an authentication process initiated by the second network element;
when the authentication is successfully passed, receiving by the third network element a subscription request of wireless information of the terminal from the second network element;
providing a wireless capability exposure service of the terminal for the second network element by the third network element in response to a subscription request of the second network element. That is, the target nRIC may subsequently continue to provide the wireless capability exposure service of the UE for the AF, thereby implementing the service switching and avoiding the interruption problem of the wireless capability exposure service of the terminal in the mobile scenario of the terminal.

In conclusion, in the mobile scenario of the terminal, after the first network element senses that the terminal moves to the third network element, the first network element notifies the second network element so as to indicate the second network element to initiate the subscription of the wireless information exposure service to the third network element, and the third network element subsequently continues to provide the wireless capability exposure service of the terminal for the second network element, thereby avoiding the interruption problem of the wireless capability exposure service in the mobile scenario of the terminal.

As shown in FIG. 7, an embodiment of the present disclosure further provides a service switching method, including following steps.
Step 701: receiving seventh information from a first network element by a fourth network element, wherein the seventh information carries service switching requirement information; and
Step 702: sending eighth information to the first network element by the fourth network element, wherein the eighth information is used to indicate the first network element to trigger service switching of the second network element.

Optionally, the first network element is a source Near-RT RIC, i.e., the Near-RT RIC of the base station (gNB) to which the terminal (UE) belongs before moving, for example, as shown in FIG. 2, the first network element is a Near-RT RIC 1, which may be referred to as nRIC1 for short.

Optionally, the third network element is a target Near-RT RIC, that is, a Near-RT RIC of the gNB to which the UE belongs after the moving, for example, as shown in FIG. 2, the third network element is a Near-RT RIC 2, which may be referred to as nRIC2 for short.

Optionally, the second network element is a service consumer of the wireless information exposure, such as an AF or a Local NEF; for example, as shown in FIG. 2, the second network element is an AF/Local NEF.

Optionally, the fourth network element is a Service Management And Orchestration (SMO) platform or a Non-Real-Time Radio access network Intelligent Controller (Non-RT RIC).

Optionally, the seventh information carries at least one of the following information:
a message type;
a service identifier allocated when the first network element provides an exposure service for the second network element;
a cause for service switching;
an identifier of a target base station;
information of the second network element;
subscription information of the second network element.

The subscription information of the second network element includes at least one of the following:
an IP address of the terminal;
identification information of the terminal;
subscribed terminal-level information.

For example, the content carried in the seventh information is shown in Table 4. The content of Table 4 has been described in the above embodiments, which will not be repeated here.

In an optional embodiment, the eighth information carries at least one of the following:
a message type;
a service identifier allocated when the first network element provides an exposure service for the second network element;
a service identifier allocated when the third network element provides an exposure service for the second network element;
a response result indicating that the sixth information is a success response or a failure response;
uniform resource locator (URL) of a subscription capability exposure service provided by the third network element for the second network element.

For example, the content carried in the eighth information is shown in Table 5. The content of Table 5 is described in the foregoing embodiments, and details are not described herein again.

In at least one embodiment of the present disclosure, the fourth network element stores network topology structure information of the nRIC, as shown in Table 1. Correspondingly, the method further includes:
receiving second information from the first network element by the fourth network element, wherein the second information is used to request the fourth network element to query a third network element corresponding to the target base station;
sending third information to the first network element by the fourth network element, wherein the third information is used to indicate a query result of the third network element.

Optionally, the first network element sends second information to the SMO or the Non-RT RIC by using an enhanced O1 or A1 interface message, to request to query third network element information corresponding to the target gNB, where the second information includes an identifier of the target gNB. The identifier of the target gNB may specifically be a Global Radio Access Network Node ID (that is, a Global RAN Node ID). The SMO or the Non-RT RIC searches for the information of the nRIC, that is, the target nRIC, to which the target gNB belongs according to the Global RAN Node ID and the table 1, and sends the information of the target nRIC to the first network element through the third information.

For example, as shown in Table 3, the third information carries at least one of the following information (the content of Table 3 is described in the foregoing embodiment, and details are not repeated herein):
an identifier (Result) indicating whether the querying is successful;
identification information of the third network element; for example, an identifier of the target nRIC;
an IP address of the third network element; for example, an IP address of the target nRIC.

In conclusion, in the moving scenario of the terminal, after the first network element senses that the terminal moves to the third network element, the first network element notifies the second network element so as to indicate the second network element to initiate the subscription of the wireless information exposure service to the third network element, and the third network element subsequently continues to provide the wireless capability exposure service of the terminal for the second network element, thereby avoiding the interruption problem of the wireless capability exposure service in the mobile scenario of the terminal.

To describe the service switching method provided in the embodiments of the present disclosure more clearly, the following describes two examples.

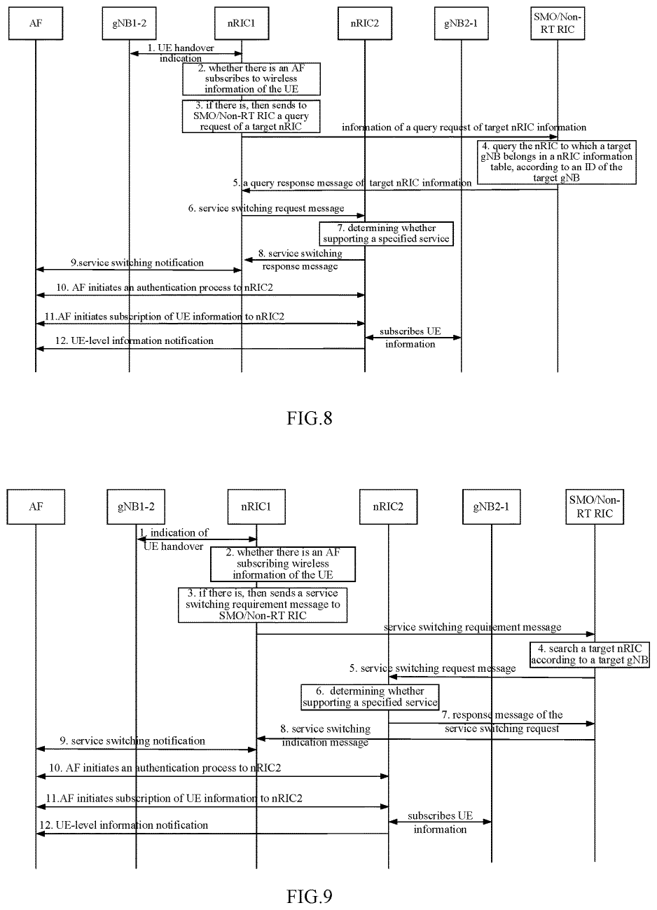

### Example 1: An Interface is Newly Added Between nRICs, as Shown in FIG. 8

Step 1: gNB 1-2 sends a UE handover indication to nRIC1 (i.e. a first network element);
Step 2: the nRIC 1 determines whether there is an AF (that is, the second network element) subscribes to the wireless information of the UE;
Step 3: If yes, the nRIC 1 sends, to the SMO/Non-RT RIC (i.e. the fourth network element), a request for querying the target nRIC (i.e., the third network element, nRIC2);
Step 4: the SMO-RT RIC queries the belonged nRIC in the nRIC information table according to the ID of the target gNB;
Step 5: the SMO Non-RT RIC sends a query response message of a target nRIC information to the nRIC1;
Step 6: the nRIC1 sends a service switching request message to the nRIC2;
Step 7: the nRIC2 judges whether a specified service is supported or not;
Step 8: if supported, the nRIC2 sends a service switching response message to the nRIC1;
Step 9: the nRIC1 sends a service switching notification to the AF;
Step 10: the AF initiates an authentication process to the nRIC2;
Step 11: the authentication is passed, and the AF initiates terminal information subscription to the nRIC2;
Step 12: the nRIC2 sends a UE-level information notification to the AF.

### Example 2: A1 Interface Enhancement Solution, as Shown in FIG. 9

Step 1: gNB1-2 sends a UE handover indication to nRIC1 (i.e. a first network element);
Step 2: the nRIC1 determines whether there is an AF (that is, the second network element) subscribes to the wireless information of the UE;
Step 3: if there is, the nRIC 1 sends a service switching demand message to the SMO/Non-RT RIC (i.e. the fourth network element);
Step 4: the SMO/Non-RT RIC queries the belonged nRIC in the nRIC information table according to the ID of the target gNB;
Step 5: the SMO/Non-RT RIC sends a service switching request message to the nRIC2;
Step 6: nRIC2 determines whether a specified service is supported; and
Step 7: if supported, the nRIC2 sends a service handover response message to the SMO/Non-RT RIC;
Step 8: the SMO/Non-RT RIC sends a service handover indication message to the nRIC1;
Step 9: the nRIC1 sends a service switching notification to the AF;
Step 10: the AF initiates an authentication process to the nRIC2;
Step 11: the authentication is passed, and the AF initiates terminal information subscription to the nRIC2;
Step 12: the nRIC 2 sends a UE-level information notification to the AF.

As shown in FIG. 10, an embodiment of the present disclosure further provides a first network element, including a processor 1000 and a transceiver 1010, where the transceiver 1010 receives and sends data under the control of the processor 1000, and the processor 1000 is configured to perform the following operations:
when receiving a handover indication of a terminal and confirming that a second network element has subscribed to wireless information of the terminal, querying a third network element;
sending first information to the second network element, wherein the first information is used to indicate the second network element to subscribe to the wireless information of the terminal from the third network element.

In an optional embodiment, the processor is further configured to perform the following operations:
parsing the handover indication of the terminal, and determining the identification information of a target base station to which the terminal hands over;
querying the third network element corresponding to the target base station based on the identification information of the target base station.

In an optional embodiment, the processor is further configured to perform the following operations:
when the first network element locally stores information of a neighbor network element, searching the locally stored information of the neighbor network element, and querying the third network element corresponding to the target base station.

In an optional embodiment, the processor is further configured to perform the following operations:
sending second information to a fourth network element, wherein the second information is used to request the fourth network element to query the third network element corresponding to the target base station;
receiving third information from the fourth network element, wherein the third information is used to indicate a query result of the third network element.

In an optional embodiment, the third information carries at least one of the following information:
an identifier indicating whether the querying is successful;
identification information of the third network element;
an IP address of the third network element.

In an optional embodiment, the processor is further configured to perform the following operations:
sending fourth information to the second network element, wherein the fourth information is used to notify the second network element that a wireless capability exposure service of the terminal is interrupted.

In an optional embodiment, the processor is further configured to perform the following operations:
sending fifth information to the third network element, wherein the fifth information is used to indicate that a terminal-level capability exposure service subscribed by the second network element needs to be switched to the third network element;
receiving sixth information from the third network element, wherein the sixth information is used to indicate a response result of the third network element.

In an optional embodiment, the processor is further configured to perform the following operations:
sending seventh information to a fourth network element, wherein the seventh information carries service switching requirement information;
receiving eighth information from the fourth network element, wherein the eighth information is used to indicate the first network element to trigger service switching of the second network element.

In an optional embodiment, the fifth information and/or the seventh information carries at least one of the following information:
a message type;
a service identifier allocated when the first network element provides an exposure service for the second network element;
a cause for service switching;
an identifier of a target base station;
information of the second network element;
subscription information of the second network element.

In an optional embodiment, the subscription information of the second network element includes at least one of the following:
an IP address of the terminal;
identification information of the terminal;
subscribed terminal-level information.

In an optional embodiment, the sixth information and/or the eighth information carries at least one of the following:
a message type;
a service identifier allocated when the first network element provides an exposure service for the second network element;
a service identifier allocated when the third network element provides an exposure service for the second network element;
a response result indicating that the sixth information is a success response or a failure response;
uniform resource locator (URL) of a subscription capability exposure service provided by the third network element for the second network element.

In an optional embodiment, the processor is further configured to perform the following operations:
when the response result of the third network element is a success response or that the eighth information is received, sending the first information to the second network element.

In an optional embodiment, the processor is further configured to perform the following operations:
when the response result of the third network element is a failure response, sending ninth information to the second network element, wherein the ninth information is used to indicate that the terminal moves to the third network element, and the third network element does not support a service to which the second network element has subscribed.

In an optional embodiment, the first information and/or the ninth information carries at least one of the following information:
information of the third network element;
identification information of a target base station to which the terminal hands over;
identification information of a target cell to which the terminal hands over;
identification information of the terminal performing handover;
an IP address of the terminal performing handover.

In an optional embodiment, the information about the third network element includes at least one of the following:
identification information of the third network element;
URL of the subscription capability exposure service provided by the third network element to the second network element;
that the third network element does not support a service to which the second network element has subscribed.

In this embodiment of the present disclosure, in the moving scenario of the terminal, after the first network element senses that the terminal moves to the third network element, the first network element notifies the second network element so as to indicate the second network element to initiate the subscription of the wireless information exposure service to the third network element, and the third network element subsequently continues to provide the wireless capability exposure service of the terminal for the second network element, thereby avoiding the interruption problem of the wireless capability exposure service in the mobile scenario of the terminal.

It should be noted that the first network element provided in the embodiments of the present disclosure is a network element capable of executing the foregoing service switching method, and all embodiments of the foregoing service switching method are applicable to the network element, and both can achieve the same or similar beneficial effects, which are not repeated herein.

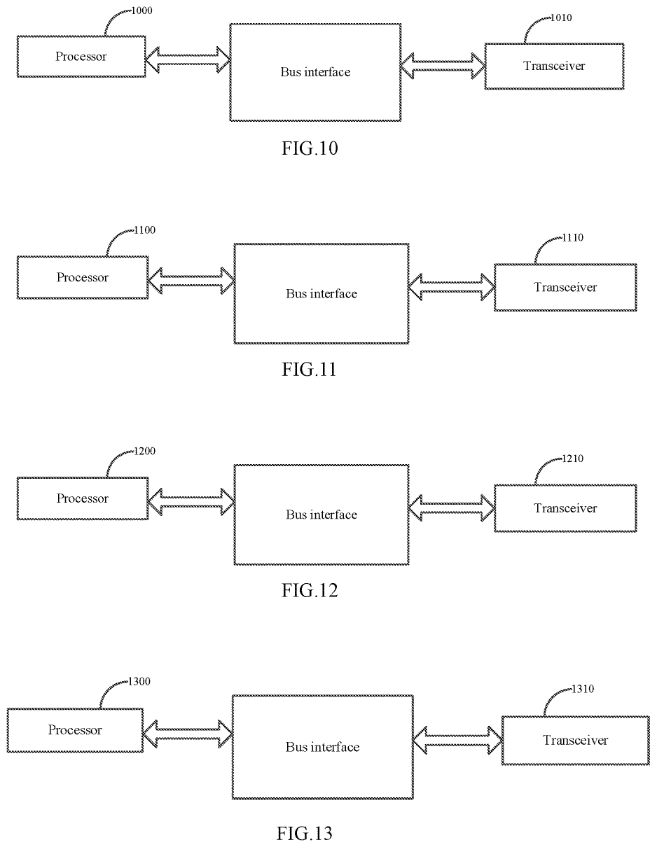

As shown in FIG. 11, an embodiment of the present disclosure further provides a second network element, including a processor 1100 and a transceiver 1110, where the transceiver 1110 receives and sends data under the control of the processor 1100, and the processor 1100 is configured to perform the following operations:
receiving first information from a first network element, wherein the second network element has subscribed to wireless information of a terminal from the first network element;
subscribing to the wireless information of the terminal from a third network element indicated by the first information according to the first information.

In an optional embodiment, the processor is further configured to perform the following operations:
receiving ninth information from the first network element, wherein the ninth information is used to indicate that the terminal moves to the third network element, and the third network element does not support a service to which the second network element has subscribed.

In an optional embodiment, the first information and/or the ninth information carries at least one of the following information:
information of the third network element;
identification information of a target base station to which the terminal hands over;
identification information of a target cell to which the terminal hands over;
identification information of the terminal performing handover;
an IP address of the terminal performing handover.

In an optional embodiment, the information of the third network element includes at least one of the following:
identification information of the third network element;
URL of the subscription capability exposure service provided by the third network element to the second network element;
that the third network element does not support a service to which the second network element has subscribed.

In an optional embodiment, the processor is further configured to perform the following operations:
initiating an authentication process to the third network element;
when authentication succeeds, subscribing to the wireless information of the terminal from the third network element, and sending a subscription deletion message to the first network element, wherein the subscription deletion message is used to indicate the first network element to delete the wireless information of the terminal subscribed by the second network element.

In this embodiment of the present disclosure, in the moving scenario of the terminal, after the first network element senses that the terminal moves to the third network element, the first network element notifies the second network element so as to indicate the second network element to initiate the subscription of the wireless information exposure service to the third network element, and the third network element subsequently continues to provide the wireless capability exposure service of the terminal for the second network element, thereby avoiding the interruption problem of the wireless capability exposure service in the mobile scenario of the terminal.

It should be noted that the second network element provided in the embodiments of the present disclosure is a network element capable of executing the foregoing service switching method, and all embodiments of the foregoing service switching method are applicable to the network element, and both can achieve the same or similar beneficial effects, which are not repeated herein.

As shown in FIG. 12, an embodiment of the present disclosure further provides a third network element, including a processor 1200 and a transceiver 1210, where the transceiver 1210 receives and sends data under the control of the processor 1200, and the processor 1200 is configured to perform the following operations:
receiving fifth information from a first network element or a fourth network element, wherein the fifth information is used to indicate that a terminal-level capability exposure service subscribed by a second network element needs to be switched to the third network element;
sending sixth information to the first network element or the fourth network element, wherein the sixth information is used to indicate a response result of the third network element.

In an optional embodiment, the fifth information carries at least one of the following information:
a message type;
a service identifier allocated when the first network element provides an exposure service for the second network element;
a cause for service switching;
an identifier of a target base station;
information of the second network element;
subscription information of the second network element.

In an optional embodiment, the subscription information of the second network element includes at least one of the following:
an IP address of the terminal;
identification information of the terminal;
subscribed terminal-level information.

In an optional embodiment, the sixth information carries at least one of the following:
a message type;
a service identifier allocated when the first network element provides an exposure service for the second network element;
a service identifier allocated when the third network element provides an exposure service for the second network element;
a response result indicating that the sixth information is a success response or a failure response;
uniform resource locator (URL) of a subscription capability exposure service provided by the third network element for the second network element.

In an optional embodiment, the processor is further configured to perform the following operations:
checking whether a target base station is managed by the third network element, whether the third network element supports a service subscribed by the second network element, and whether capability of the third network element itself can support service subscription of the second network element;
when the checking is all passed, determining that the response result of the third network element is the success response; or, when at least one of the checking fails, determining that the response result of the third network element is the failure response.

In an optional embodiment, the processor is further configured to perform the following operations:
responding to an authentication process initiated by the second network element;
when the authentication is successfully passed, receiving a subscription request of wireless information of the terminal from the second network element;
providing a wireless capability exposure service of the terminal for the second network element by the third network element in response to a subscription request of the second network element.

In this embodiment of the present disclosure, in the moving scenario of the terminal, after the first network element senses that the terminal moves to the third network element, the first network element notifies the second network element so as to indicate the second network element to initiate the subscription of the wireless information exposure service to the third network element, and the third network element subsequently continues to provide the wireless capability exposure service of the terminal for the second network element, thereby avoiding the interruption problem of the wireless capability exposure service in the mobile scenario of the terminal.

It should be noted that, the third network element provided in the embodiments of the present disclosure is a network element capable of executing the foregoing service switching method, and all embodiments of the foregoing service switching method are applicable to the network element, and both can achieve the same or similar beneficial effects, which are not repeated herein.

As shown in FIG. 13, an embodiment of the present disclosure further provides a fourth network element, including a processor 1300 and a transceiver 1310, where the transceiver 1310 receives and sends data under the control of the processor 1300, and the processor 1300 is configured to perform the following operations:
receiving seventh information from a first network element, wherein the seventh information carries service switching requirement information;
sending eighth information to the first network element, wherein the eighth information is used to indicate the first network element to trigger service switching of the second network element.

In an optional embodiment, the seventh information carries at least one of the following information:
a message type;
a service identifier allocated when the first network element provides an exposure service for the second network element;
a cause for service switching;
an identifier of a target base station;
information of the second network element;
subscription information of the second network element.

In an optional embodiment, the subscription information of the second network element includes at least one of the following:
an IP address of the terminal;
identification information of the terminal;
subscribed terminal-level information.

In an optional embodiment, the eighth information carries at least one of the following:
a message type;
a service identifier allocated when the first network element provides an exposure service for the second network element;
a service identifier allocated when the third network element provides an exposure service for the second network element;
a response result indicating that the sixth information is a success response or a failure response;
uniform resource locator (URL) of a subscription capability exposure service provided by the third network element for the second network element.

In an optional embodiment, the processor is further configured to perform the following operations:
receiving second information from the first network element, wherein the second information is used to request the fourth network element to query a third network element corresponding to the target base station;
sending third information to the first network element, wherein the third information is used to indicate a query result of the third network element.

In an optional embodiment, the third information carries at least one of the following information:
an identifier indicating whether the querying is successful;
identification information of the third network element;
an IP address of the third network element.

In this embodiment of the present disclosure, in the moving scenario of the terminal, after the first network element senses that the terminal moves to the third network element, the first network element notifies the second network element so as to indicate the second network element to initiate the subscription of the wireless information exposure service to the third network element, and the third network element subsequently continues to provide the wireless capability exposure service of the terminal for the second network element, thereby avoiding the interruption problem of the wireless capability exposure service in the mobile scenario of the terminal.

It should be noted that the fourth network element provided in the embodiments of the present disclosure is a network element capable of executing the foregoing service switching method, and all the embodiments of the foregoing service switching method are applicable to the network element, and both can achieve the same or similar beneficial effects, which are not repeated herein.

An embodiment of the present disclosure further provides a network element, where the network element is a first network element or a second network element or a third network element or a fourth network element, the network element includes a memory, a processor, and a computer program stored in the memory and executable on the processor, and when the processor executes the program, each process in the foregoing service switching method embodiments is implemented, and the same technical effect can be achieved, which is not described herein again in order to avoid repetition.

An embodiment of the present disclosure further provides a computer-readable storage medium, on which a computer program is stored, and when the program is executed by a processor, each process in the foregoing service switching method embodiments is implemented, and the same technical effect can be achieved. The computer-readable storage medium is, for example, a read-only memory (Read-Only Memory, ROM), a Random Access Memory (RAM), a magnetic disk, or an optical disk.

A person skilled in the art should understand that the embodiments of the present disclosure may be provided as a method, a system, or a computer program product. Therefore, the present disclosure may take the form of an entire hardware embodiment, an entire software embodiment or an embodiment combining software and hardware aspects. Moreover, the present disclosure may take the form of a computer program product implemented on one or more computer-readable storage media (including but not limited to a disk memory, an optical memory, and the like) including computer-usable program codes.

The present disclosure is described with reference to the flowcharts and/or block diagrams of the method, the device (system) and the computer program product according to the embodiments of the present disclosure. It should be understood that computer program instructions may be used to implement each process and/or block in the flowcharts and/or the block diagrams and a combination of a process and/or a block in the flowcharts and/or the block diagrams. These computer program instructions may be provided to a processor of a general purpose computer, special purpose computer, embedded processor, or other programmable data processing apparatus to produce a machine, such that the instructions executed by the processor of the computer or other programmable data processing apparatus generate means for implementing the functions specified in the flowchart one or more flows and/or one or more blocks.

These computer program instructions may also be stored in a computer-readable storage medium capable of guiding a computer or other programmable data processing devices to work in a specific manner, so that the instructions stored in the computer-readable storage medium generate a product including an instruction apparatus, and the instruction apparatus implements the functions specified in one or more flows of the flowcharts and/or one or more blocks in the block diagrams.

These computer program instructions may also be loaded onto a computer or other programmable data processing device to cause a series of operational steps to be performed on the computer or other programmable device to produce a computer-implemented process, such that the instructions executed on the computer or other programmable device provide steps for implementing the functions specified in one or more flows of the flowchart and/or one or more blocks of the block diagram.

The above are preferred embodiments of the present disclosure, and it should be noted that, for a person of ordinary skill in the art, several improvements and modifications may be made without departing from the principle of the present disclosure, and these improvements and modifications should also be considered as the protection scope of the present disclosure.

1. A service switching method, comprising:
when a first network element receives a handover indication of a terminal and confirms that a second network element has subscribed to wireless information of the terminal, querying a third network element by the first network element; and
sending first information to the second network element by the first network element, wherein the first information is used to indicate the second network element to subscribe to the wireless information of the terminal from the third network element.

2. The method according to claim 1, wherein the querying a third network element by the first network element comprises:
parsing the handover indication of the terminal by the first network element, and determining identification information of a target base station to which the terminal hands over;
querying, by the first network element, the third network element corresponding to the target base station based on the identification information of the target base station.

3. The method according to claim 2, wherein querying, by the first network element, the third network element corresponding to the target base station according to the identification information of the target base station comprises:
when the first network element locally stores information of a neighbor network element, searching the locally stored information of the neighbor network element by the first network element, and querying the third network element corresponding to the target base station.

4. The method according to claim 2, wherein querying, by the first network element, the third network element corresponding to the target base station according to the identification information of the target base station comprises:
sending second information to a fourth network element by the first network element, wherein the second information is used to request the fourth network element to query the third network element corresponding to the target base station;
receiving third information from the fourth network element by the first network element, wherein the third information is used to indicate a query result of the third network element.

5. The method according to claim 4, wherein the third information carries at least one of the following information:
an identifier indicating whether the querying is successful;
identification information of the third network element;
an IP address of the third network element.

6. The method according to claim 1, wherein when querying the third network element fails, the method further comprises:
sending fourth information to the second network element by the first network element, wherein the fourth information is used to notify the second network element that a wireless capability exposure service of the terminal is interrupted;
or,
when querying the third network element succeeds, then before the first network element sends the first information to the second network element, the method further comprises:
sending fifth information to the third network element by the first network element, wherein the fifth information is used to indicate that a terminal-level capability exposure service subscribed by the second network element needs to be switched to the third network element;
receiving sixth information from the third network element by the first network element, wherein the sixth information is used to indicate a response result of the third network element;
or,
when querying the third network element succeeds, then before the first network element sends the first information to the second network element, the method further comprises:
sending seventh information to a fourth network element by the first network element, wherein the seventh information carries service switching requirement information;
receiving eighth information from the fourth network element by the first network element, wherein the eighth information is used to indicate the first network element to trigger service switching of the second network element.

7-8. (canceled)

9. The method according to claim 6, wherein the fifth information and/or the seventh information carry at least one of the following information:
a message type;
a service identifier allocated when the first network element provides an exposure service for the second network element;
a cause for service switching;
an identifier of a target base station;
information of the second network element;
subscription information of the second network element.

10. The method according to claim 9, wherein the subscription information of the second network element comprises at least one of the following:
an IP address of the terminal;
identification information of the terminal;
subscribed terminal-level information.

11. The method according to claim 6, wherein the sixth information and/or the eighth information carry at least one of the following:
a message type;
a service identifier allocated when the first network element provides an exposure service for the second network element;
a service identifier allocated when the third network element provides an exposure service for the second network element;
a response result indicating that the sixth information is a success response or a failure response;
uniform resource locator (URL) of a subscription capability exposure service provided by the third network element for the second network element.

12. The method according to claim 6, wherein sending the first information to the second network element by the first network element comprises:
when the response result of the third network element is a success response or that the eighth information is received, sending the first information to the second network element by the first network element.

13. The method according to claim 76, further comprising:
when the response result of the third network element is a failure response, sending ninth information to the second network element by the first network element, wherein the ninth information is used to indicate that the terminal moves to the third network element, and the third network element does not support a service to which the second network element has subscribed.

14. The method according to claim 12, wherein the first information and/or the ninth information carry at least one of the following information:
information of the third network element;
identification information of a target base station to which the terminal hands over;
identification information of a target cell to which the terminal hands over;
identification information of the terminal performing handover;
an IP address of the terminal performing handover.

15. The method according to claim 14, wherein the information of the third network element comprises at least one of the following:
identification information of the third network element;
URL of the subscription capability exposure service provided by the third network element to the second network element;
that the third network element does not support a service to which the second network element has subscribed.

16-20. (canceled)

21. A service switching method, comprising:
receiving fifth information from a first network element or a fourth network element by a third network element, wherein the fifth information is used to indicate that a terminal-level capability exposure service subscribed by a second network element needs to be switched to the third network element;
sending sixth information to the first network element or the fourth network element by the third network element, wherein the sixth information is used to indicate a response result of the third network element.

22. The method according to claim 21, wherein the fifth information carries at least one of the following information:
a message type;
a service identifier allocated when the first network element provides an exposure service for the second network element;
a cause for service switching;
an identifier of a target base station;
information of the second network element;
subscription information of the second network element;
and/or,
wherein the sixth information carries at least one of the following:
a message type;
a service identifier allocated when the first network element provides an exposure service for the second network element;
a service identifier allocated when the third network element provides an exposure service for the second network element;
a response result indicating that the sixth information is a success response or a failure response;
uniform resource locator (URL) of a subscription capability exposure service provided by the third network element for the second network element;
and/or,
wherein before sending the sixth information to the first network element or the fourth network element by the third network element, the method further comprises:
checking, by the third network element, whether a target base station is managed by the third network element, whether the third network element supports a service subscribed by the second network element, and whether capability of the third network element itself can support service subscription of the second network element;
when the checking is all passed, determining that the response result of the third network element is the success response; or, when at least one of the checking fails, determining that the response result of the third network element is the failure response.

23. The method according to claim 22, wherein the subscription information of the second network element comprises at least one of the following:
an IP address of the terminal;
identification information of the terminal;
subscribed terminal-level information.

24-25. (canceled)

26. The method according to claim 21, further comprising:
responding by the third network element to an authentication process initiated by the second network element;
when the authentication is successfully passed, receiving by the third network element a subscription request of wireless information of the terminal from the second network element;
providing a wireless capability exposure service of the terminal for the second network element by the third network element in response to a subscription request of the second network element.

27. A service switching method, comprising:
receiving seventh information from a first network element by a fourth network element, wherein the seventh information carries service switching requirement information;
sending eighth information to the first network element by the fourth network element, wherein the eighth information is used to indicate the first network element to trigger service switching of the second network element.

28. The method according to claim 27, wherein the seventh information carries at least one of the following information:
a message type;
a service identifier allocated when the first network element provides an exposure service for the second network element;
a cause for service switching;
an identifier of a target base station;
information of the second network element;
subscription information of the second network element;
and/or,
wherein the eighth information carries at least one of the following:
a message type;
a service identifier allocated when the first network element provides an exposure service for the second network element;
a service identifier allocated when the third network element provides an exposure service for the second network element;
a response result indicating that the sixth information is a success response or a failure response;
uniform resource locator (URL) of a subscription capability exposure service provided by the third network element for the second network element.

29-30. (canceled)

31. The method according to claim 27, further comprising:
receiving second information from the first network element by the fourth network element, wherein the second information is used to request the fourth network element to query a third network element corresponding to the target base station;
sending third information to the first network element by the fourth network element, wherein the third information is used to indicate a query result of the third network element.

32-38. (canceled)
